(19) United States
(12) Patent Application Publication
(10) Pub. No.: US 2004/0090312 A1
(43) Pub. Date: May 13, 2004

(54) Power line communication system with autonomous network segments

(76) Inventors: Constantine N. Manis, Monmouth Junction, NJ (US); Oleg Logvinov, East Brunswick, NJ (US); Lawrence Durfee, Washington, NJ (US)

Correspondence Address: Lorimer P. Brooks, Esq., Norris, McLaughlin & Marcus, P.O. Box 1018, Somerville, NJ, 08876-1018, US

(21) Appl. No.: 10/280,555

(22) Filed: Oct. 25, 2002

Related U.S. Application Data
(60) Provisional application No. 60/345,933, filed on Oct. 27, 2001.

(51) Int. Cl. H04M 11/04

(52) U.S. Cl. 340/310.02

(57) ABSTRACT

A plurality of access units, each coupled to a different portion of a medium voltage power line, are also coupled to a broadband signal network for receiving, and supplying, broadband communication signals from and to the broadband network and for receiving, and supplying, communication signals from and to the power line as the transmission path between the access unit and repeaters coupled to the medium voltage power line and lower voltage power lines which supply electrical power to customers' premises. The access units can also receive and transmit electromagnetic energy, e.g. radio frequency, infrared and/or optical energy, modulated with the communication signals over a transmission path different from the medium voltage power line and at least some of the repeaters can receive and transmit the so-modulated electromagnetic energy. Preferably, controllers are provided at the access units and the at least some of the repeaters to activate the electromagnetic energy transmissions when the power line signal reception at the repeaters is significantly degraded.

### RELATED APPLICATIONS

Benefit of provisional application Serial No. 60/345,933, filed Oct. 27, 2001 and in the names of the inventors named herein, is claimed and such application is incorporated herein by reference.

### FIELD OF THE INVENTION

The present invention relates to power line communication (PLC) systems for high speed, broadband access using existing medium voltage (MV) electrical power distribution networks, and particularly, to how the communications access points are deployed and how communications are distributed to the low voltage (LV) electrical power distribution network. In an embodiment, there are provided alternate transmission paths between the apparatus which couples a broadband network, e.g. the Internet, to a medium voltage (MV) power line and the apparatus which couples the MV power line to the low voltage (LV) power line at a customer's premises, e.g. a home, business building, etc.

### BACKGROUND OF THE INVENTION

Power line communication (PLC) systems are well known in the art. See, for example, Chapter 6 of the book entitled “The Essential Guide to Home Networking Technologies” published in 2001 by Prentice-Hall, Inc., copending U.S. application Ser. No. 09/290,255, filed Apr. 12, 2999, the web site http:/www/houseplug.org of the Home Plug Special Interest Group and page 42 of the Communications International Magazine, March 2000.

The delivery of broadband data communications (e.g., Internet traffic, . . . ) over existing MV power distribution networks is very attractive primarily because the wires are already in place, the network exists in all locations where communications is desirable and proven PLC technology makes available ample communications bandwidth. Deployment of this capability involves placing access concentrators at various points along the power network. PLC signals launched into the MV power distribution network will tend to degrade along the length of the network. Adequate performance under these circumstances is insured through the use of repeaters and multiple access points. Another important aspect of power line communications is that different segments of the power distribution network will have different PLC capacity, reliability and delay characteristics. This means the reach of a PLC access point may differ from segment to segment.

It is common practice in prior art electrical power distribution systems in the United States to provide MV power lines, e.g. at voltages of the order of 2000 volts, which extend from a distribution station to the vicinity of electrical power customers. At selected locations, a power transformer is connected to the MV lines and to low voltage (LV) lines, e.g. at voltages of the order of 230 volts or less, which in turn are connected to a plurality of the buildings, such as homes, office buildings, etc., of electrical power customers. At the transformers, there is apparatus, such as a Repeater (PTR), which couples the communication signals between the MV lines and the LV lines to reduce the communication signal power loss which would otherwise be caused by the transformer.

The communication signals are supplied to the MV lines from the broadband network and supplied to the broadband network from the MV lines, by apparatus, such as the apparatus sometimes known as an Access Point Concentrator (APC).

However, the communication signals which reach the PTR by way of the MV line can, as mentioned hereinbefore, be degraded or intermittently be of insufficient magnitude to be useful due to the different electrical characteristics, at communication signal frequencies, of the MV line.

Such characteristics can be different from segment to segment of the MV line and can change dynamically from time to time.

The invention overcomes problems created by the characteristic of PLC networks to exhibit different communications attributes along the length of a power distribution network. These attributes can change not only from network segment to network segment but they can also change dynamically from one time to another time. A concept of this invention is to use, in addition to PLC links, multiple alternate communication links to compensate for static and dynamic segment conditions. In addition to saving installation costs and reducing installation time, this invention provides a capability to dynamically adapt the network to maintain optimal communications performance.

### BRIEF SUMMARY OF THE INVENTION

In accordance with the preferred embodiment of the invention, the known type of apparatus (APC) for coupling communication signals between the broadband network and the MV lines is modified so as to be capable of also coupling the communication signals between the APC and a Multiple Technology Repeater (MTR) by electromagnetic energy transmitted over a path which is an alternate for the MV line path. One or more of the known type of PTR is modified to receive electromagnetic energy from, and transmit electromagnetic energy to, the so modified APC and along the alternate path. Controllers responsive to the transmission characteristics of the MV transmission path determine dynamically which transmission path will be used for the signals being transmitted. Also, in the event that the length of the MV line is such that the communication signals are significantly degraded at a portion thereof which is a substantial distance from the portion of the MV power line to which the APC is coupled, a second APC is coupled to the MV line at a portion of the line spaced from the portion of the MV line to which the other APC is coupled.

The electromagnetic energy transmitted over the alternate path can be, for example, radio frequency, infra-red or optical energy, and the APC and the selected MTR's include components for receiving and sending such energy. The transmission medium can be air or a cable suitable for transmitting, with low loss, the energy being transmitted

### BRIEF DESCRIPTION OF THE DRAWINGS

The invention will be better understood by reference to the attached drawings in which:

FIG. 1 is a schematic diagram of a power line communication system incorporating apparatus of the invention;

FIG. 2 is a block diagram of an access point concentrator (APC) which can be used in the system of the invention;

FIGS. 3A and B are block diagrams illustrating, respectively, the coupling of an MTR of the invention and a PTR between an MV power line and an LV power line;

FIG. 4 is a block diagram illustrating the components of an MTR of the invention and a prior art PTR and their coupling to MV and LV power lines; and

FIG. 5 is a block diagram of a portion of a power line communication system incorporating components of the invention.

### DETAILED DESCRIPTION OF PREFERRED EMBODIMENTS

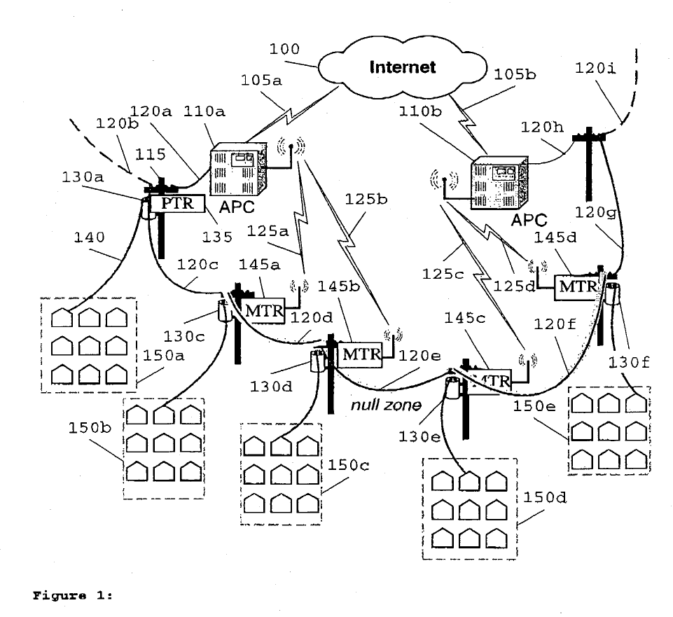

FIG. 1 shows one possible deployment of multiple access points (APC—Access Point Concentrator), PLC repeaters (PTR—PLC technology MV/LV repeaters) and multiple communications technology repeaters (MTR—Multiple Technology MV/LV Repeater) in an MV (medium voltage) and LV (low voltage) electric power distribution network. APC and MTR devices are designed to use multiple communications technologies with PLC technology being the primary. The use of RF communications technology is implied in the diagram, but other technologies including, but not limited to fiber optics, infrared and others could be substituted.

A simplified example of an MV power distribution system (MV powerlines #120a, #120c, #120d, #120e, #120f, #120g, #120h, including continuations to additional destinations with MV powerlines #120b and #120i) with PLC capabilities is shown in FIG. 1. Broadband communications data from, for example, the Internet (#100) through a, for example, fiber optic link (#105a and #105b)are connected to the MV power distribution network (#120a and #120h)via the APC units (#110a and #110b). Two APC units, instead of a single APC unit, are attached to the network to further the reach of the PLC signals beyond what a single APC unit could attain. The PTR (#135) and MTR (#145a, #145b, #145c, #145d) units located at several points along the network, repeat the MV PLC signals to LV networks (#140) where the information to be consumed terminates in houses and places of business (#150a, #150b, #150c, #150d, #150e). The APC units (#110a and #110b) communicate to the MTR's (#145a and #145d) both through the MV distribution network with PLC techniques and also with RF methods (#125a, #125d) in this simplified example. MTR's (#145b and #145c) communicate to their respective APC's (#110a and #110b) using only RF (#145b and #145c) in this case. Using management communications functions, the APC receives information from each MTR/PTR about the characteristics of the PLC links and each MTR about the RF links at every segment. This data are used to determine the optimal logical link topology to use (some combination of PLC links and RF links) in any given situation. Also, note that null zones (MV powerlines #120d, #120e, #120f) are planned at segments between multiple APC units, as shown in FIG. 1, so that there is no interference between multiple APC signals on the same MV network. The MTR unit would provide communications via its RF link for these null zones. In this example, MTR #145c and MTR #145d are located in null zones and therefore they would not receive a useable PLC signal. Furthermore, the signals from the two APC's (#110a and #110b) would not interfere with each other since their signals are severely attenuated within the null zone. The MTR's (#145b and #145c) use the RF signal (#125b and #125c) to communicate to their respective consumption points (#150c and #150d). Notice that some MTR's (#145a and #145d) use their respective RF links (#125a and #125d) as an alternate communications path since presumably they normally have a high quality PLC signal to use. Having these alternate communications path improves reliability and at a lower cost (both installation costs and operational costs). High reliability is important for guaranteed services such as packetized voice (e.g., telephony, etc.), audio and video.

### 1. Network Considerations

It is important to point out that the MTR units RF link communicate directly to the APC unit. Contrast this with a topology were MTR units RF link communicate with each other in a daisy chain fashion, one after the other, eventually connecting to an APC. Direct communications between an MTR and its associated APC unit is a key requirement because it allows central control by the APC. It also adds extra redundancy to the communications network, for both data and command traffic, to recover from a PLC link failure or other severe impediment.

### 2. Key Equipment

The three key network elements are the APC units, the MTR units and the PTR units.

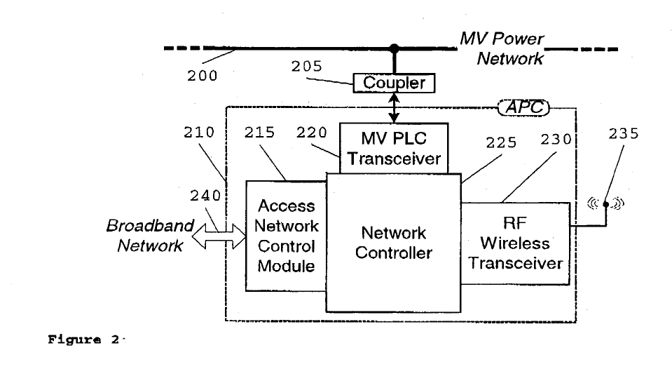

The internal blocks of the APC (blocks #110a and #110b FIG. 1) are shown in FIG. 2. There are three (3) primary external interfaces; broadband network, MV power network and RF antenna. The data flow between all these interfaces is controlled by the block labeled Network Controller.

The APC (see FIG. 2) is primarily responsible for connecting broadband data (#240) with the MV distribution network using PLC technology (#200 using coupler #205). It also has an RF link (#235) to individual MTR's that can be used to route communications from the broadband network. Another function is to continuously monitor network performance with data requested from the remote MTR/PTR units and then command the MTR units to route traffic with the best possible logical topology of PLC links and wireless links (note that each MTR has at least two possible paths to choose from). The overall set of selected links is aimed at some form of optimal network performance in terms of highest capacity, foremost reliability, lowest delay or other depending on the service provider.

There are three (3) main elements to the APC: two transceivers, the MV PLC Transceiver (#220) and the RF Wireless Transceiver (#230 or other communications technology), the Access Network Controller Module (#215) and the Network Controller (#225).

The point to multi-point MV PLC transceiver (#220) implements MV PLC MAC/PHY functionality to provide two logical communications paths to the MV powerline: control channel and data channel. The high-speed two-way data channel is used as the primary way to communicate between broadband sites and the final consumption points. The control channel is used to exchange performance data and management information/commands between the APC and all attached MTR/PTR units as well as possibly consumption points. The MV PLC transceiver it electrically coupled to the powerline with the coupler (#205).

The (logical) point to point RF Wireless Transceiver (#230) implements an RF MAC/PHY (one or more of any scheme) and, like the MV PLC transceiver, also has dual logical channels one for data exchange and one for control information exchange. It is important to point out that RF technology is used here for exemplary purposes only and that any other technology such as fiber optics or infrared could be utilized just as effectively depending on the circumstances. The RF Wireless Transceiver logically communicates with a single MTR, but physically, due to positioning of the MTR's for example, may communicate point to multi-point.

The Access Network Control Module (#240) manages the connection to the broadband network (e.g., Internet, PSTN, etc.). This connection could be any of a number of physical connections including fiber optics, Ti and so on. The connection depends on how the service provider chooses to attach. This module provides the data path between broadband sites and the APC (which routes to consumption points).

The primary controlling element in the APC is the Network Controller (#225). It manages communications traffic between the broadband network and each consumption point over some combination of PLC links and RF links. The majority of the communication paths will be made up of PLC links as the RF links are for exception cases (e.g., null zones, unusable PLC links, etc.). The Network Controller gathers performance data from all the PTR's and MTR's in its network as well as data from its own ports. Performance parameters could include, but are not limited to:

Instantaneous and average throughput

Maximum and minimum throughput over a given period

Instantaneous and average latency

Maximum and minimum latency over a given period

Number of error packets received over a given period

Instantaneous, average, maximum and minimum traffic volume per consumption point

Instantaneous, average, best and worst signal quality

Etc.

This information can be used in a variety of ways to optimize the network performance based on goals set by the service provider. It could be used to re-route traffic away from a failed PLC link through an RF link. It could be used to re-route traffic away from a PLC link that has suddenly exhibited degraded throughput. Historical data collected by the Network Controller could be used to predict expected performance anomalies and traffic could be re-routed away from problem links.

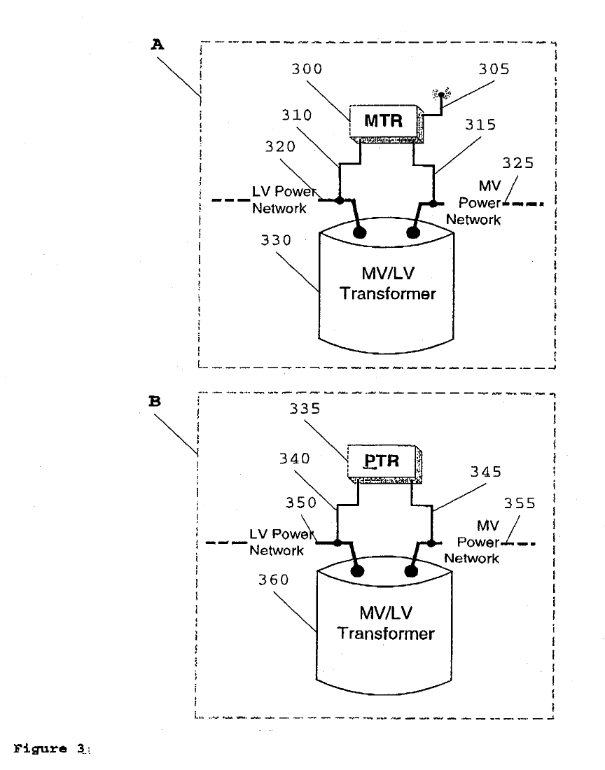

FIG. 3 shows how PTR's (#135 in FIG. 1; #300 in this figure) and MTR's (blocks #145a, #145b, #145c, and #145d in FIG. 1; #335 in this figure) are connected to the various powerline networks (#310, #315, #340 and #345). The MV/LV transformer (#330 and #360) is designed to step down the voltage between sections of the power distribution network. They severely attenuate PLC signals from the primary (#325 and #355) to the secondary (#320 and #350) windings and therefore a PLC repeater is necessary (#300 and #335). In this example, the MTR has an RF transceiver connected to an antenna (#305).

### MTR Unit

MTR and PTR repeaters are needed in the network to overcome the severe reduction in PLC signal strength as it travels through an MV/LV power transformer (the resultant signal is unusable). Therefore, the primary function of the MTR is to facilitate communications between the MV network and the LV network using either, as requested by the APC, an MV-PLC scheme or an RF scheme (any other communications technology could be used as well). It also collects operational and performance information and sends it to the APC as needed.

A repeater capable of communications using two or more technology will be more expensive than a single PLC technology repeater. Furthermore, since the logical connection between APC and MTR is point to point, the cost of the APC will be increased as more and more MTR units are added to the MV network. Another consideration to reducing the cost of the APC is that planned null zones eliminate the need to deal with interference between two APC units on the same MV network. The cost of MTR's over the cost of PTR's is quickly offset with the savings in installation, maintenance and improved system performance (e.g., higher capacity, greater reliability, lower delays, etc.).

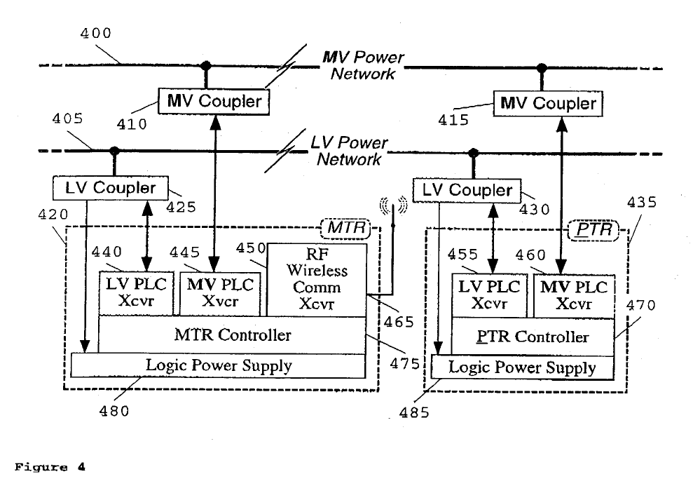

The internal elements of an exemplary MTR are shown in FIG. 4 (#420). Power to operate the pole mounted MTR is derived from the LV powerline (#405) by using the LV coupler (#425) to the internal power supply (#480). The LV coupler also supplies the PLC signal to the PLC transceiver (#440). The purpose of the LV coupler (#425) is to safely tap power and PLC signals from the LV powerline (#405) for the MTR. The MV coupler (#410) functions to safely connect PLC signal with the MTR on the MV powerline (#400).

The basic operation of the LV PLC transceiver (#440) and the MV PLC transceiver (#445) are similar except that the MAC and PHY would be tailored to their respective channel and respective operational parameters. Some channel and operational differences would include, but are not limited to, the following:

Physical length of the MV network is usually much longer than that of the LV network. The physical lengths will be vastly different and the length determines the electrical characteristics of the line, for example.

MV traffic is higher because it is a shared channel with more destinations, whereas the LV link consists of only traffic from the attached consumption points (in the realm of 10's of consumption points). This means, for example, that the characteristic of the LV MAC and MV MAC will be different depending on the maximum number of end-points serviced.

Transceivers for one or more alternate communications paths are illustrated in this example by a single RF transceiver (#450). It should be noted that this disclosure is not limited to RF but others such as IR, fiber optics or others could be used to support the alternate communications need. This disclosure is also not limited to a single alternate path, as in this example, but several could be implemented in a single MTR unit. The RF transceiver implements the MAC/PHY functionality for any of a number of logical point-to-point wireless schemes. These transceivers can be used in two different ways in a typical installation. The RF transceiver acts as a backup path to the powerline link, in some cases (#145a and #145d) and, in other more common cases (#145b and #145c) as a way to backhaul traffic from the APC to LV network segments located in null zones.

The primary function of the MTR controller (#475) is to mange traffic between the MV PLC link, the LV PLC link and the alternate communications path, the RF link in this example. The controller may implement certain standard networking functions. The MTR controller may include DHCP (Dynamic Host Configuration Protocol) to simplify LV end-point configuring, for one example. The HTTP (Hypertext Transfer Protocol) function may be another example and would be used to remotely configure the MTR itself using a familiar web page like interface. Another important function of the MTR controller is to continuously collect operational data and forward it to the APC on demand using either the MV PLC link or the alternate communications path (e.g., using the RF transceiver).

### PTR Unit

Like the MTR units, the PTR units are primarily used to communicate traffic between the MV network and the LV network. Unlike the MTR units, the PTR units use only one communications technology, namely PLC. Also, like the MTR, they provide operational data as requested by the APC, related to the present communication link characteristics. In any MV network, it is likely that the PTR units will outnumber MTR units by a wide margin. The cost of the PTR units will be less than that of a MTR unit and in any practical North American powerline network, MV/LV repeaters will number in the 100's or more.

In FIG. 4, PTR (#435) operating power (#485) and connecting MV/LV signals with the respective MV/LV powerlines (#400/#405) using the respective MV/LV couplers (#415/#430) function much the same as mentioned above for the MTR equivalents. The MV/LV PLC transceivers (#455/#460) also function identically to their MTR counterparts. The PTR controller block (#470) is also very similar to its MTR corresponding item except, of course, there is no alternate communications path controller element included.

### Network Example

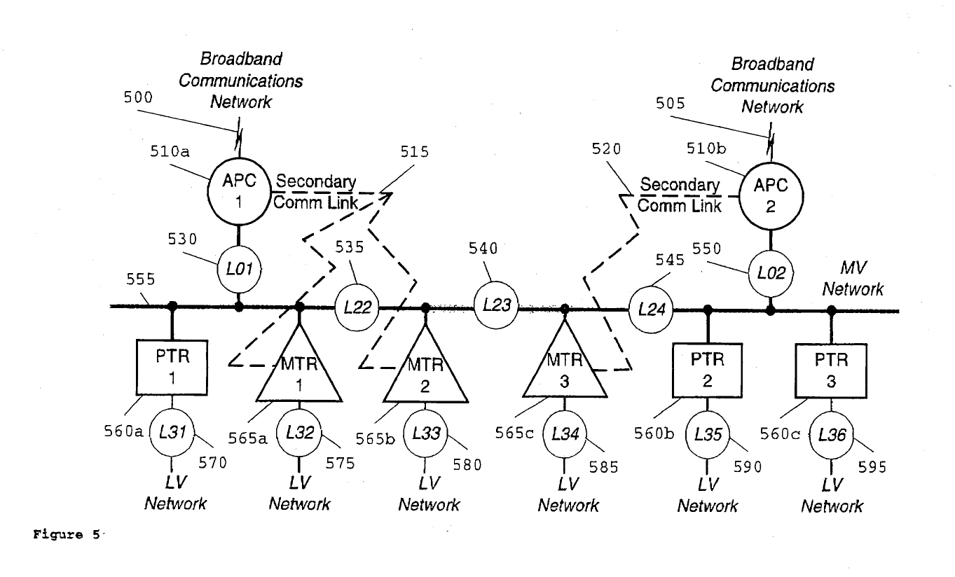

An example to illustrate how this works is shown in FIG. 5. The example sub network consists of two APC units (#510a and #510b), three PTR units (#560a, 560b and 560c) and three MTR units (#565a, #565b, and #565c). Each APC has a secondary communications channel (RF link in this case; #515 and #520) connected to an MTR. Each APC also connects to the broadband network (e.g., the Internet; #500 and #505). The various PLC segments are labeled with a circle containing a unique identifier (e.g., the segment between MTR1, #565a, and MTR2, #565b, is labeled L22, #535). This sub network is designed so that segment L23 (#540) is a null zone to eliminate interference between APC1 and APC2. Under normal circumstances, MTR2 (#565b)and MTR3 (#565c) would use PLC modes of operation to connect the MV PLC signals to segments L33 (#580) and L34 (#585) respectively. Likewise, MTR1 would use MV PLC signals to establish communications with segment L32 (#575). During normal operation all PTR's and MTR's would regularly communicate operational information to their respective APC on request. MTR's would communicate information on both PLC and secondary links (the secondary links in this example are RF links). Assume that at some point in time the segment L22 (#535) PLC communications becomes degraded. APC1 would then command MTR2, using its RF link, to use its RF link for all traffic destine for link L33 (#580). Once the problem on link L22 is resolved, APC1 would revise the network configuration back to its normal state.

Consider the installation process whereby normally, for example, repeaters are needed every ¾ miles. However, because of a unique loading condition at one ¾ mile segment (say link L24, #545,in FIG. 5), the PLC characteristics are unusable (e.g., low capacity, excessive retransmissions required, etc.). In this case, MTR3 could always be commanded to use its RF link to carry traffic for link L34. This would eliminate the need to install additional MV/MV repeaters or other equipment. Without the use of MTR's, extensive testing during the installation process would have to be done to verify that each segment has adequate performance over time. Since this installation process would be very expensive, the use of MTR's is a major advantage. Furthermore, if at some point link L24 is rebuilt and problems are eliminated, PLC traffic can then resume with no PLC related installation costs incurred.

Although preferred embodiments of the invention have been described, it will be apparent to those skilled in the art that various modifications can be made. For example, it is not necessary that the APC units be coupled to the MV line at portions sufficiently far apart to create a null zone, and instead, interference between the signals supplied by the APC units can be avoided or reduced by causing the signals supplied to the MV line by one APC to have characteristics, e.g. frequency, modulation, etc., different from the characteristics of the signals supplied to the MV line by the other APC.

Also, although not preferred, instead of using two types of repeaters, i.e. PTR units and MTR units, all the repeaters can be MTR units.

In addition, if desired, the APC units can simultaneously supply the communication signals to the MV line and transmit such signals over the alternate electromagnetic energy path, eg. the air, fiber or cable path. In such event, the MTR controller can make the determination of which signal to be supplied to the LV line based on the degradation of the signals received by way of the two transmission paths.

The invention is also useful when a high voltage power line, e.g. at a voltage much higher than a medium voltage power line, is the transmission medium in place of a medium voltage power line.

The invention is also useful as an alternate communications path within zones even where the PLC communication path is working correctly.

What is claimed is:

1. In a power line communication system in which an access unit is coupled to a broadband signal network and to a first power line of a predetermined voltage for supplying communication signals to the power line which correspond to the network signals and supplying broadband signals to the network which correspond to communication signals on the power line and in which repeaters with a communication signal receiver and transmitter are coupled to the first power line and to lower voltage power lines providing low voltage power to the premises of customers for supplying communication signals to the low voltage power lines and supplying communication signals from the low voltage power lines to the first power line, the improvement comprising:
at least two said access units, one of which is coupled to a first portion of the first power line and another of which is coupled to a second portion of the first power line which is spaced from the first portion of the first power line, each access unit comprising a communication signal transmitter and a communication signal receiver coupled to the first power line and also comprising an electromagnetic energy transmitter and receiver for transmitting and receiving electromagnetic energy modulated with communication signals over a transmission medium different from the first power line and a network controller coupled to the communication signal transmitter and receiver and to the electromagnetic energy transmitter and receiver for controlling the activation of the communication signal transmitter and receiver and the activation of the electromagnetic energy transmitter and receiver; and
at least one said repeater for receiving and transmitting the communication signals from and to the first power line, the one said repeater having an electromagnetic receiver for receiving electromagnetic energy modulated with communication signals from an access unit and providing communication signals to the low voltage line and having an electromagnetic energy transmitter for transmitting electromagnetic energy modulated with communication signals received from the low voltage power line to the access unit, the one said repeater also comprising a flow controller coupled to the communication signal receiver and transmitter and to the electromagnetic energy receiver and transmitter for controlling the flow of communication signals between the low voltage lines and the receivers and transmitters of the one said repeater.

2. A power line communication system as set forth in claim 1 wherein the electromagnetic energy is radio frequency energy and the different transmission medium is air.

3. A power line communication system as set forth in claim 1 wherein the electromagnetic energy infra red energy and the different transmission medium is air.

4. A power line communication system as set forth in claim 1 wherein the electromagnetic energy is optical energy and the different transmission medium is a cable.

5. A power line communication system as set forth in claim 1 wherein the first power line attenuates the signals supplied thereto and wherein the spacing between the first and second portions of the first power line is such that there is a null zone intermediate the first and second portions.

6. A power line communication system as set forth in claim 5 wherein one said repeater is coupled to the first power line at one side of, and adjacent to, the null zone and wherein another said repeater is coupled to the first power line at the other side of, and adjacent to, the null zone.

7. In a power line communication system in which communication signals are applied to and received from a first power line at a predetermined voltage as the transmission medium and are transferred between the first power lines and lower voltage power lines by repeaters and in which the electrical characteristics of the first power line are such as to cause the communication signals at a repeater to be degraded, the method of improving the signal at said repeater which comprises:
providing multi-technology repeaters which can process the communication signals applied to the first power line and also process electromagnetic energy modulated with the communication signals;
determining when the communication signals at the multi-technology repeater and applied to the first power line are degraded; and
responsive to a determination that the first power line communication signals at the multi-technology repeater are degraded, transmitting electromagnetic energy modulated with the communication signals to the multi-technology repeater by way of a transmission medium other than the first power line.

8. Method as set forth in claim 7 wherein the electromagnetic energy is radio frequency energy and the other transmission medium is air.

9. Method as set forth in claim 7 wherein the electromagnetic energy is infrared energy and the other transmission medium is air.

10. Method as set forth in claim 7 wherein the electromagnetic energy is optical energy and the other transmission medium is an optical fiber cable.
